(19) United States
(12) Patent Application Publication
(10) Pub. No.: US 2004/0152055 A1
(43) Pub. Date: Aug. 5, 2004

(54) Video based language learning system

(76) Inventors: Michael J.G. Gliessner, Hong Kong (HK); Mark S. Knighton, Santa Monica, CA (US); Todd C. Moyer, Los Angeles, CA (US); Peter J. DeLaurentis, Marina Del Rey, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/356,166

(22) Filed: Jan. 30, 2003

(51) Int. Cl. G09B 19/00; G09B 5/00

(52) U.S. Cl. 434/169; 434/156

(57) ABSTRACT

Language learning system using pre-existing entertainment media such as feature films on DVD in connection with augmented language-learning content stored in a companion file. A player for viewing the augmented content and the entertainment media. An editor to create and manage companion source files and create associations with the entertainment media.

### BACKGROUND

(1) Field of the Invention

The invention relates to language learning tools. Specifically, the invention relates to a language learning tool that uses video entertainment content to teach a language.

(2) Background

Learning a language can be a tedious process due to the dull language exercises in the typical language textbooks. Textbooks typically consist of vocabulary, grammar and reading lessons. These lessons repeat the usage of a small set of words and grammatical constructs in the form of generic sentences and subject matter. Occasional dialogues and stories are short and of minimal interest to a language student. Software language products are typically digital reproductions of the techniques embodied in the textbooks including vocabulary and grammar drills to teach a student the language. These language products fail to combine text, audio and video with compelling stories and information that engages the student's interest in the material and motivates their study.

Entertaining materials in a language are not accessible to beginning and intermediate learners because these materials are too quickly paced and laden with idioms, slang and unconventional sentence structures. There is no easy method of parsing or analyzing the materials to facilitate the student's understanding of the language in the material. However, typical entertainment materials such as feature films and television shows are more engaging than the dry drills and generic subject matter of a textbook or typical language education materials.

### BRIEF DESCRIPTION OF THE DRAWINGS

Embodiments of the invention are illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

FIG. 1 is a diagram of a video language system.

FIG. 2 is a diagram of a video playback system.

FIG. 3 is an illustration of a playback screen.

FIG. 4 is a flow-chart of a video playback speed adjustment system.

FIG. 5 is a flow-chart of a video playback augmentation system.

FIG. 6 is a diagram of a companion source file format.

FIG. 7 is a flow-chart of a companion source file creation system.

FIG. 8 is a diagram of a video language editing system.

FIG. 9 is an illustration of a video editing system.

FIG. 10 is a flow-chart of a module access control system.

### DETAILED DESCRIPTION

In one embodiment, an interactive video language learning system includes a player software application that allows a user to play a DVD or a similar audio/video medium containing entertainment material (e.g., a feature film) with augmented features that assist in the learning of a language. Augmented features may include a transcription in a language to be learned, language learning tools such as dictionaries, grammar information, phonetic pronunciation information and similar language related information. The player application system uses a companion file that is stored separately from the associated entertainment material. The companion file contains the information necessary to create the augmented features for the entertainment material that are geared toward language learning. The companion files are created with the use of an editing application that allows an editor to assemble language learning materials into companion files to be used in coordination with the entertainment material.

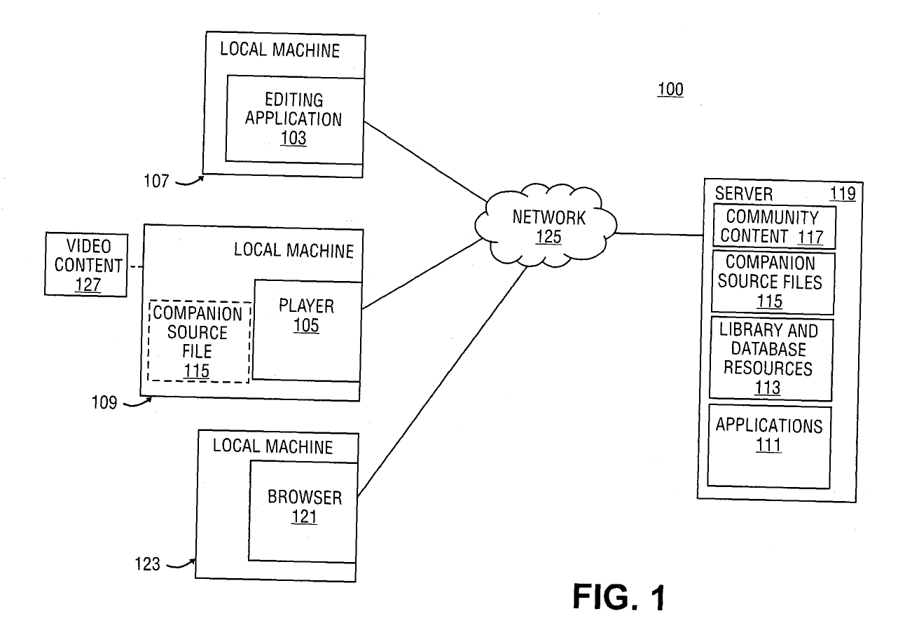

FIG. 1 is a diagram of the interactive video language learning system 100. In one embodiment, system 100 includes a player program 105 designed to run on a local machine 109. Player program 105 is the user interface for system 100. An individual interested in learning a language uses player 105 to play entertainment media with augmented language assistance features. Player program 105 combines stored video content 127 with a companion source file 115 to provide the augmented entertainment content. Player program 105 can operate on a stand-alone local machine 109 when video content 127 and companion source files 115 are locally accessible. In another embodiment, player program 105 can access video content 127 or companion source files 115 over a network 125.

In one embodiment, server system 119 provides additional databases and resources 113 to be used in conjunction with companion source files 115 and video content 127 to assist the learning of a language. In one embodiment, server 119 also stores and offers for download companion sources files 115 accessible by player 105. In one embodiment, server 119 offers web based content and fora 117 related to video content 127 and language learning.

In one embodiment, system 100 includes an editing application 103 to create and modify companion source files 115 and other content for use with video content 127. In one embodiment, editing application 103 is configured to operate on local machine 107. Local machine 107 may be a desktop or laptop computer, an Internet appliance, a console system or similar device capable of running a browser application. Editing application 103 interacts with server 119 over network 125 to obtain companion source modules (subcomponents of a companion source file) through applications 111 such as version control software, web server software and similar applications. Network 125 may be a LAN, private network, the Internet or similar system. In one embodiment, editing application 103 can also access web based content and fora 117 hosted by server 119 and access library database resources 113.

In one embodiment, system 100 includes a browser 121 running on local machine 123. Browser (e.g., Internet Explorer® by Microsoft® Corporation) is able to access, over network 125, web content, fora 117, databases and other language resources on server 119. In one embodiment, local machine 123 may be a desktop or laptop computer, an Internet appliance, a console system or similar device capable of running a browser application.

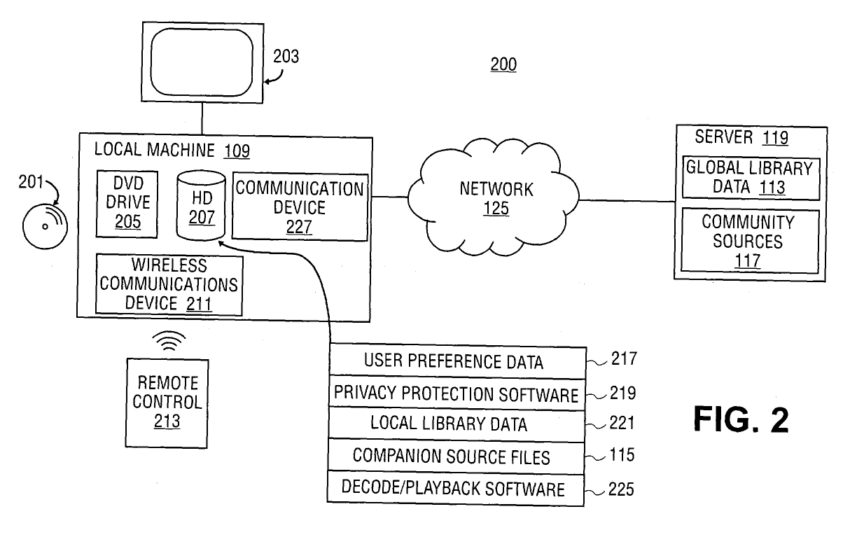

FIG. 2 illustrates a playback system 200 that enables a user to view video content 127 stored on media 201 using local machine 109 and display device 203. A local machine 109 may be a desktop or laptop computer, an Internet appliance, a console system (e.g., the Xbox® manufactured by Microsoft® Corporation) or similar device. Player 105 accesses and plays video content 127 from a random access storage device 205 attached to local machine 109 (e.g., on DVD, CD, hard drive or similar mediums) and associates video content 127 thereon with a companion source file 115 that provides additional content to augment video content 127. Companion source file 115 is independent of video content 127 and is sourced from a separate medium. This permits language learning to occur, e.g., using off-the-shelf DVDs. In various embodiments, the random access storage media storing video content 127 may be one of a CD, DVD, magnetic disk, optical storage medium, local hard disk file, peripheral device, solid state memory medium, network-connected storage resource or Internet-connected storage resource. Companion file 115 resides on a separate storage medium 207 that may also be any of the above listed media types. While video content 127 and additional content/source files are on a separate media, they may be retained on a same or different media type. For example, video content 127 may be an off-the-shelf DVD 201 and the additional content may be on a CD or the additional content may be on a separate DVD.

In one embodiment, display device 203 may be a cathode ray tube based device, liquid crystal display, plasma screen, or similar device that is capable of interfacing with local machine 109. Local machine 109 includes a removable media reading device 205 to access video content 127 of media 201. Reading device 205 may be a CD, DVD, VCD, DiVX or similar drive. In one embodiment, local drive 109 includes a storage system 207 for storing player software 105, decode/video software 225, companion source data files 115, local language library software 221, piracy protection software 219, user preferences and tracking software 217 and other resource files for use with player software 105. Media 201 and storage system 207 may be a CD, DVD, magnetic disk, hard disk, peripheral device, solid state memory medium, network connected storage medium or Internet connected device. In one embodiment, local machine 109 includes a wireless communications device 211 to communicate with remote control 213. Remote control 213 can generate input for player software 105 to access language information and adjust playback of video content 127. Communication device 227 connects local machine 109 to network 125 and server 119.

In one embodiment, piracy protection software 219 includes a system where video content 127 is uniquely identified to ensure that a user has a legal copy of that content. In one embodiment, companion source file 115 or some portion thereof is encrypted and inaccessible until it is verified that the user has the proper permissions to access the file (e.g., a legitimate copy of video content 127, registration with the language learning service and similar criteria). In one embodiment, piracy protection software 219 manages local copies of video content 127 and companion source files 115 to ensure that a single local copy is used when authorized and deleted when authorization is lost or an authorized media is removed from system 200. In one embodiment, piracy software 219 determines if an authorized copy of video content 127 is available by accessing it on media 201. If media 201 is not available access to a local copy is limited or eliminated.

In one embodiment, server 119 provides access by player software 105 to global language library software and databases 113, web based content and fora 117 and similar resources. In one embodiment, player software 105 is capable of browsing web based content, supports chat rooms and other resources provided by server 119.

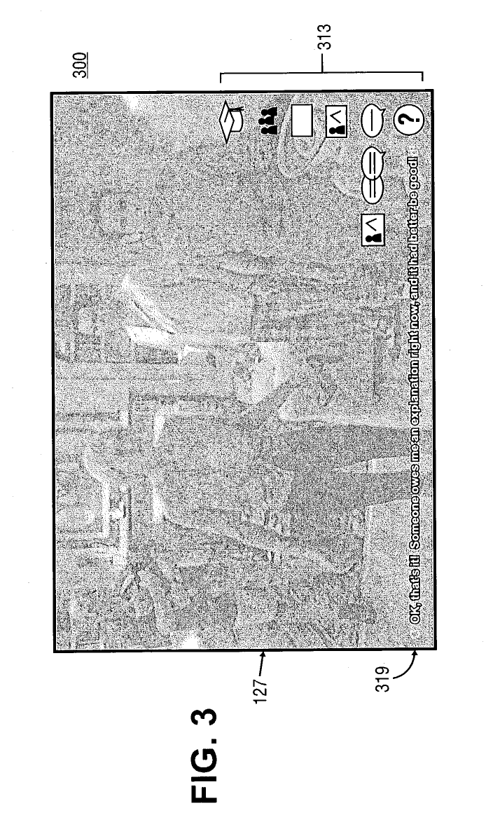

FIG. 3 is an exemplary screen shot of player software 105. In one embodiment, video content 127 is obtained from, e.g., a DVD 201 in a local drive 205 and the additional content is obtained from, e.g., local hard disk 207. Player software 105 associates the additional content with video content 127 during playback to augment the playback of video content 127. This may, in one embodiment, take the form of overlaying captions 319 on a sequence of video frames corresponding to the words spoken while those frames are displayed. Captions 319 may then be highlighted as the words of the soundtrack are spoken. Highlighting caption 319 is deemed to include any visual mechanism to accent a part of the caption. This may include, e.g., changing the color in a current word, underlining as words are spoken, shadowing as words are spoken, bolding the word being spoken, etc. Other additional content such as preamble and post amble material are discussed in detail below.

Companion source file 115 will typically include additional content that may be used to augment video content 127 during playback. The additional content may include without limitation any or all of an index of words spoken in the soundtrack of video content 127 in association with the frames at which spoken, captions in one or more languages that track a transcript of the soundtrack, definitions of any or all words used in video content 127 with or without pronunciation aids, idioms used in video content 127 with or without definitions, usage examples for word and/or idioms, translations of existing subtitles, and similar content. As used herein, captions 319 may include a transcript of the soundtrack from video content 127 corresponding to the frames displayed and may appear at any location on display 203. Thus, captions 319 are deemed to include subtitles, dialogue balloons, etc. Pronunciation aids may include text based pronunciation keys (e.g., use of phonetic spelling conventions) as found in conventional dictionaries or audio “correctly” pronounced words previously recorded or generated by computer.

It is recognized that subtitles existing in video content 127 are often, at best, loose translations of the words actually spoken. Accordingly in one embodiment, the additional content includes (or consists of) translations of existing subtitles. This may be at substantial variance with a true transcript of the spoken dialogue. In one embodiment, the player performs subtitle translations on the fly and displays the translation associated with the original subtitles during the playback of video content 127.

In one embodiment, the player software 105 provides a graphical user interface (GUI) to allow a user to drill deeper into the additional content. For example, a user may be able to click on a word in a caption and get a definition for the word from the dictionary in the companion source file 115. A navigation facility may also be provided such that, e.g., clicking on a word in the dictionary will transport the user to the place(s) in video content 127 where the word is used. The GUI may also provide the user the ability to repeat an arbitrary portion of the content viewed. For example, soft buttons may be provided to cause a repeat of the previous line, dialogue exchange, or entire scene. The random access nature of both video content 127 and the additional content permits a user to specify to an arbitrary degree of granularity what portion of video content 127 and associated additional content to view. Thus, a user may elect to view a scene, dialogue exchange or merely a line within video content 127. The ability to repeat with arbitrary granularity also enhances the learning experience. The GUI may also provide the user the ability to control the speed and/or pitch of the soundtrack to facilitate understanding of the dialogue. Speed may be adjusted by inserting spaces between words while maintaining the normal pitch and speed of the actual words spoken.

In one embodiment, player 105 supports full screen and windowed modes. In the full screen mode player 105 displays video content 127 according the to the limits in the dimensions of video content 127. In one embodiment, the GUI includes a set of icons 313 or navigational tools that are superimposed over a part of displayed video content 127 by player software 105. In another embodiment, icons 313 are displayed above or below video content 127 (e.g., icons may be displayed in screen space caused by letterboxing or similar techniques). In one embodiment, icons 313 allow a user to access additional language content by use of a peripheral input device such as a mouse, keyboard, remote control 213 or similar device. In one embodiment, scrolling text or captions 319 are superimposed on video content 127 or displayed adjacent to video content 127.

In one embodiment, captions, GUI and similar content are created by overlaying the additional graphical content over the base video content frame using back buffering. Video content 127 is buffered after being decoded or read from its source media 201 as an off-screen bitmap or in a similar format prior to being displayed. Text, captions, icons and other GUI elements are drawn over the base video content frame. The text, captions and materials from companion source files 115 are read from a separate storage medium 207 than video content 127. The altered video frame is then drawn onscreen using standard platform dependent techniques (e.g., BitlBlt operations in Microsoft Windows®).

In one embodiment, graphical elements have semi-transparent properties to minimize the level to which video content 127 is obscured. In one embodiment, graphical elements such as icons are stored in a 32 bit format. The alpha channel in the 32 bit format associated with each graphical element allows 256 distinct levels of transparency ranging from invisible to opaque. In one embodiment, as each pixel is drawn over the video frame in the off-screen buffer, it is combined with every pixel underneath it using a blending function for each of the RGB channels of the 32 bit format. In one embodiment, the following formula is used to blend the pixels by channel:

New Pixel Value (for each color channel)=(1−(Alpha Value/255))*Video Pixel Value+(Alpha Value/255)*Graphic Pixel Value

In one embodiment, text elements have semi-transparent properties to minimize the level to which the underlying video content is obscured. In addition, text and captions may be highlighted. In one embodiment, the highlighting is a glow around the highlighted word. Text is drawn using operating system supported functions such as true-type, mathematical text drawing techniques or by drawing pre-rendered images onto the buffered video frame. If text is stored as a set of pre-rendered images it would be drawn onto the video frame in the same manner as graphical elements. To affect the glow highlighting, the pre-rendered graphical text would be blurred in an initial frame and its alpha value would be substantially reduced. The normal rendering of the graphic text would then be drawn over the blurred image to produce the glowing affect. In the true-text or mathematical techniques transparency is inherent to the system because pixels are only drawn for the text and not for gaps or spaces in the text. In one embodiment, a glow affect is created by drawing multiple versions of the word at different sizes, brightness levels and transparency levels. The actual text is then drawn over the glow area created. These sequences can be a part of an animation of the highlighting of the text by progressing and then diminishing the brightness and size of the glow affect over a sequence of frames.

In one embodiment, icons 313 link video content 127 to dictionaries, video catalogs and guides and similar language reference and navigation tools. These links cause player 105 to display specialized screens to show the user the relevant content. In one embodiment, an icon links to an explanation screen that lists idioms in a segment of video content 127 in multiple languages. Specialized screens accessible through icons 313 also display information about word definitions, slang, grammar, pronunciation, etymology and speech coaching, as well as access menus, character information menus and similar features. In another embodiment, alternative navigation techniques are used to access special content such as hot keys, hyperlinks or similar techniques and combinations thereof. In one embodiment, when specialized screens are accessed, the video content is minimized or reduced in size to create space in the display to view the additional content while still allowing the viewing of the video playback if appropriate. Video content 127 acts as an icon to return to full screen mode when the user is finished reviewing the materials of the specialized screen. In another embodiment, video content 127 is not displayed while specialized content is displayed.

The dictionary data displayed on specialized screens is accessible by icons 313. The dictionary data may be video content 127 specific. For example, it may include a definition of the word as used in video content 127 but not all definitions of the word. The dictionary data may contain definitions and related words in a language other than the language of video content 127. The dictionary data may include other data of interest that is general or unique to the particular video content 127. Data of interest may include a translation of the word into another language, an example of a usage of the word, an idiom associated with the word, a definition of the idiom, a translation of the idiom into another language, an example of usage of the idiom, a character in video content 127 who spoke the word, an identifier for a scene in which the word was spoken, a topic which relates to the scene in which the word was spoken or similar information. Such data may be retained in a database, flat file or companion source file segment with associated links to permit a user to jump directly to a relevant portion of video content 127 from the content in the database.

Player 105 also tracks user input and playback position within video content 127 in order to allow the resumption of playback after pausing or stopping the playback of video content 127. Additionally, by tracking user behavior, the system is able to respond to user input more intelligently. For example, if a user requests a line be repeated, the first time the system may repeat the line at normal speed, the second time the system may, for example, increase the time spacing between the word (while maintaining pitch and speed of the words) and if a third repeat is requested, the dialogue may be constructed from prerecorded words spoken by an articulate speaker. By tracking both the user input and the context in which it occurs, the player is better able to enhance the learning experience. This is, of course, only one example of how the historical user behavior may be used to facilitate the language learning process. It is within the scope and contemplation of the invention for the player to employ a rule based inference engine to intelligently handle user inputs based on prior user behavior. Moreover, such behavior may be tracked only during a current session or over a plurality of sessions. Thus, for example, if the user behavior is tracked over multiple sessions, the inference engine may identify pattern weakness in a particular area and provide more information sooner in such areas in subsequent sessions.

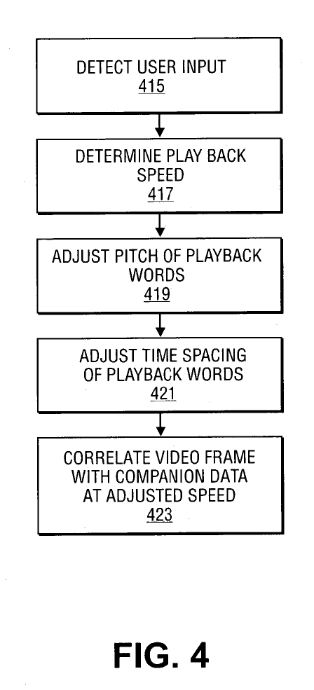

FIG. 4 is a flow-chart illustrating the process of adjusting the playback of video content 127. A user can adjust the playback of video content 127 including audio tracks associated with video content 127 using a peripheral device connected either directly or wirelessly with local machine 109. A peripheral device may be a mouse, keyboard, trackball, joystick, game pad, remote control 213 or similar device. Player software 105 receives input from peripheral device 213 (block 415). In one embodiment, player software 105 determines that this input is related to the playback of video content 127 including determining the desired playback speed and start point for the playback (block 417). Player software queues video content 127 to the desired start position and begins playback of video content 127, player software 105 adjusts the frame rate of video content 127 in accordance with the input from the peripheral device. In one embodiment, player software 105 also adjusts the pitch of the words being spoken on the audio track associated with video content 127 (block 419). In one embodiment, player software 105 adjusts the timing and spacing of the words being played back at the adjusted speed in order to enhance the discrete set of sounds associated with each word to facilitate the understanding of the words by the user (block 421). The time spacing is adjusted without affecting the pitch of speech rate. In one embodiment, player software 105 correlates the data between video content 127 and the companion source data file at an adjusted speed, including displaying captions at the adjusted speed, highlighting words in the captions at an adjusted speed and similar speed related adjustments to the augmented playback (block 423). In one embodiment, the user can select a type of playback based on individual words, sentences, length of time or similar manners of dividing the audio track of video content 127.

In one embodiment, peripheral device 213 provides input to player software 105 that determines the type of adjusted playback to be provided. Upon receiving a first input (e.g., a click of a button) from peripheral input device 213, player software 105 repeats a segment of video content 127 at normal speed. If two inputs are received in a predefined period then player software 105 replays a video content segment at a slower rate using the time spacing and pitch adjustment techniques. If three inputs are received in the predefined period then player software 105 plays back the video segment using audio from a library of articulated words. If four input signals are received in the predefined time period then player 105 displays drill-down screens related to the sentence in the relevant video segment. Drill-down screens include phonetic, grammar and similar information related to the sentence and may be displayed in combination with the slowed audio or audio from the library.

In one embodiment, player software 105 includes a speech coaching subprogram to assist a user in correct pronunciation. The speech coaching program provides an interface that works in conjunction with the adjusted playback features to playback segments of the audio track associated with video content 127 at a reduced speed to facilitate the user's understanding of the audio track. In one embodiment, the speech coaching program allows a user with an audio peripheral input device (e.g., a microphone or similar device) to repeat the selected audio segment. In one embodiment, the speech coaching program provides recommendations, grading or similar feedback to the user to assist the user in correcting his speech to match speech from the audio track. In one embodiment, the user can access a set of varying pronunciations that have been pre-recorded, listen to the pronunciation of a line by a character or listen to a computer voice reading of the relevant section of a transcript. In one embodiment, the correct phonetic pronunciation of a word or set of words is displayed. If a user records a pronunciation then the phonetic equivalent of what the user recorded will be displayed for comparison and feedback. The speech coaching program displays a graphical representation of the correct pronunciation such that the user can compare his recorded pronunciation to the correct pronunciation. This graphical representation may be, for example, a waveform of the recorded audio of the user displayed adjacent to or overlapping a correct pronunciation. In another embodiment, the graphical representative is a phonetic computer generated transcription of the recorded audio allowing the user to see how his pronunciation compares to a correct phonetic spelling of the words being recorded. The recorded user audio and correct pronunciation may also be displayed as a bar graph, color coded mapping, animated physiological simulation or similar representation.

In one embodiment, player software 105 includes an alternative playback option that allows the transcript of a video content 127 to be played with another voice such as an actor's voice or a computer generated voice. This feature can be used in connection with the adjusted playback feature and the speech coach feature. This assists a user when the audio track is not clear or does not use a proper pronunciation.

In one embodiment, player software 105 displays an introduction screen, preamble screens and postamble screens attached at the beginning and end of a video content 127 and segments of video content 127. The introduction screen is a menu that allows the user to choose the options that are desired during playback. In one embodiment, the user can select a set of preferences to be tracked or used during playback. In one embodiment, the user can select ‘hot word flagging’ that highlights a select set of words in a transcript during playback. The words are highlighted and ‘hint’ words may also be displayed that help explain or clarify the meaning of the highlighted word. In one embodiment, words that a user has difficulty with are flagged as ‘hot words’ and are indexed or cataloged for the user's reference. The user may enable bookmarking, which allows a user to mark a scene during playback to be returned to or indexed for later viewing. In one embodiment, the introduction screen allows a choice of language, user level, specific user identification and similar parameters for tailoring the language learning content to the user's needs. In one embodiment, user levels are divided into beginning, intermediate, advanced and fluent. Each higher level displays more advanced content or less assisting content than the lower levels. In one embodiment, an introduction screen may include advertisements for other products or video content 127.

In one embodiment, preamble screens may be attached to the beginning of a scene. In one embodiment, words and idioms associated with a scene may be displayed in a preamble screen. Words and information displayed will be in accord with the specified user level. In one embodiment, preamble screens introduce material before a video content 127 section including: words in the segment, word explanations, word pronunciations, questions relating to video content 127 or language, information relating to the user's prior experience and similar material. Links in the preamble allow a user to start playback at a specific frame. For example, a preamble may have a link between the preamble and a word occurring in the scene, to allow the user to jump directly to the frame in video content 127 in which the word is used. In one embodiment, a user may set preferences that prevent the display of some or all preamble screens, or show them only on reception of further input. In one embodiment, screen shots or other images or animations are used in the preamble screens to illustrate a word or concept or to identify the associated scene. In one embodiment, a set of pre-rendered images for use in preamble screens is packaged as a part of player software 105. In one embodiment, preamble screens are not displayed unless the user ‘opts-in’ to avoid disrupting the natural flow of video content 127.

In one embodiment, preamble screens include specific words, phrases or grammatical constructs to be highlighted for the learning process. The relevant material from a companion file 115 related to a scene is compiled by player software 105. Player software 105 analyzes the user level data associated with each data item in the scene and constructs a list of the relevant type of data that corresponds to the user level or meets user specified preferences or criteria. In one embodiment, additional material related to the scene may be added to the list such as “hot words” regardless of its indicated user level. Material that tracking data stored by player software 105 indicates the user understands well or has already been tested on by previous preamble screens is removed from the list. Random or pseudo-random functions are then used to select a word, phrase, grammatical construct or the like from the assembled list to be used in the preamble screen. In another embodiment, the words or information displayed on a preamble screen is chosen by an editor or inferred from data collected about the user.

In one embodiment, the postamble screen is an interactive testing or trivia program that tests the user's understanding of language and content related to video content 127. In one embodiment, questions are timed and correct and incorrect answers result in different screens or video content 127 being displayed. In one embodiment, if a timeout occurs, the correct answer is displayed.

In one embodiment, postamble material is at the end of a scene or video content 127. In one embodiment, content and questions are generated automatically based on tracked user input during the viewing of video content 127. For example, segments of the video that the user had difficulty with based on a number of replays are replayed in order of difficulty during the postamble. In one embodiment, content from other video content may be used or cross referenced with content from the viewed video content 127 based on similar language content, characters, subject matter, actors or similar criteria. In one embodiment, postamble screens display language and vocabulary information including links similar to the preamble screen. Postamble screens may be deactivated or partially activated by a user in the same manner as preamble screens. In one embodiment, screen shots or other images or animations are used in the postamble screens to illustrate a word or concept or to identify the associated scene. In one embodiment, a set of pre-rendered images for use in postamble screens is packaged as a part of player software 105. Player software 105 accesses companion source file 115 to determine when to insert preamble and postamble screens and associated content. In one embodiment, all postamble screens are ‘opt-in’ except once video content 127 has ended, e.g., at the end of the movie in which case the postamble will be supplied unless the user ‘opts-out’ by providing an input.

In one embodiment, as discussed above, player software 105 tracks user preferences and actions to better test the augmented playback information to the user's needs. User preference information includes user fluency level, pausing and adjusted playback usage, drill performance, bookmarks and similar information. In one embodiment, player software 105 compiles a customizable database of words as a vocabulary list based on user input.

In on embodiment, user preferences are exportable from player software 105 to other devices and machines for use with other programs and player software 105 on other machines. In one embodiment, server 119 stores user preferences and allows a user to log in to server 119 to obtain and configure local player software 105 to incorporate the preferences.

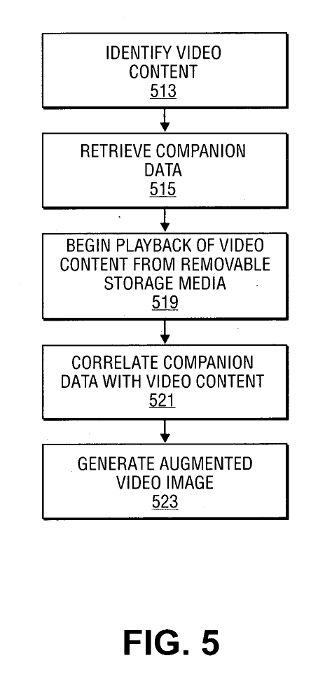

FIG. 5 is a flow-chart of a player software 105 process of linking a companion source file 115 to video content 127. Player software 105 identifies video content 127 that the user wishes to view (block 513). In one embodiment, player software 105 accesses video content 127 to find an identifying data sequence and correlates that sequence to a companion source file 115 using a local or remote database or by sending locally accessible companion source files 115. Once video content 127 has been identified, player software 105 determines if a copy of the appropriate companion source file 115 is available locally. In one embodiment, the companion source file may be stored on a removable media storage article such as a CD or similar storage media. In one embodiment, if companion source file 115 is not available locally, player software 105 accesses server 119 over network 125 to download the appropriate companion source file (block 515). In one embodiment, player software 105 then begins the video access and playback of video content 127 (block 519). In one embodiment, player software 105 correlates video content 127 and companion source file 115 on a frame by frame basis (block 521). In one embodiment, companion source file 115 contains information about video content 127 based on a set of indices associated with each frame in video content 127 in a sequential manner. Player software 105, based on the frame of video content 127 being prepared for display, accesses the related data in companion source file 115 to generate an augmented playback. Related data may include transcripts, vocabulary, idiomatic expressions, and other language related materials related to the dialogue of video content 127. In one embodiment, companion source file 115 may be a flat file, database file, or similar formatted file. In one embodiment, companion source file 115 data is encoded in XML or a similar computer interpreted language. In another embodiment, companion source file 115 will be implemented in an objected-oriented paradigm with each word, line, and scene instance represented by an instance of an object of an appropriate class.

In one embodiment, player 105 uses companion source file 115 data to augment the playback of video content 127 (block 523). The augmentation may include a display of captions, phonetic pronunciations, icons that link to additional menus and features related to video content 127 such as guides, menus, and similar information related to video content 127. In one embodiment, other resources available through player software 105 and companion source files 115 include: grammatical analysis and explanation of sentence structures in the transcript, grammar-related lessons, explanation of idiomatic expressions, character and content related indices and similar resources. In one embodiment, player 105 would access an initial line or scene section and use the information therein to find the starting position in the word index and the corresponding starting frame. Playback would continue sequentially through each section unless diverted by user input requesting access to specific information or jumping to a different position in video content 127.

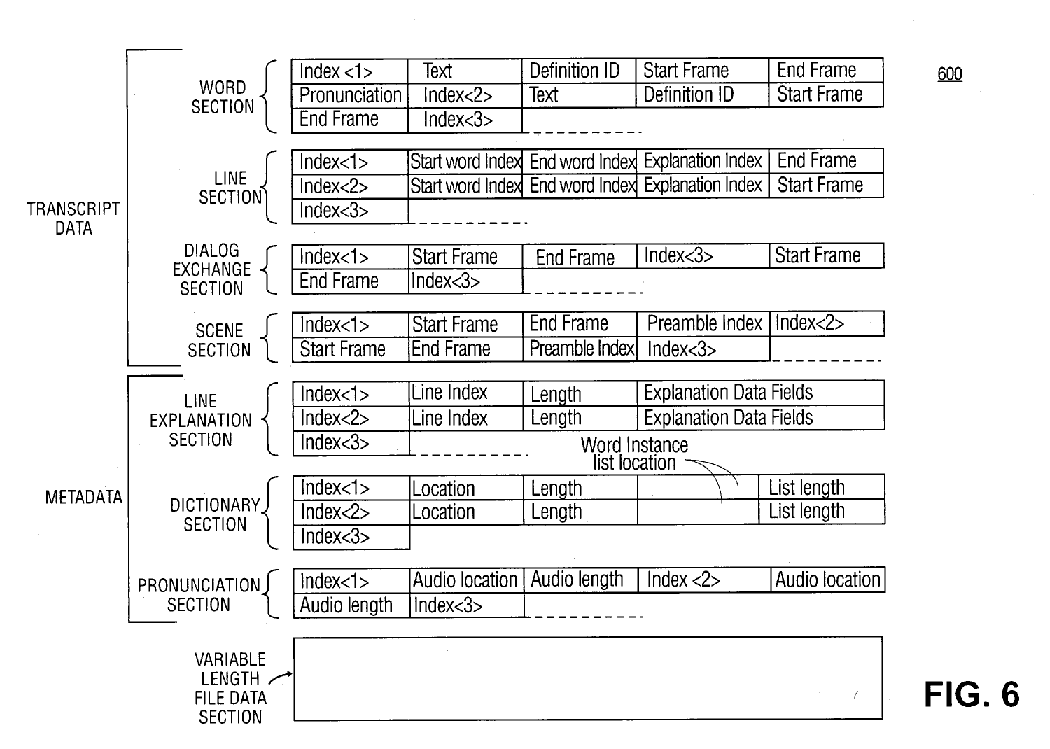

FIG. 6 is a diagram of a exemplary companion source file format. In one embodiment, the companion source files 115 are divided into transcript related data and metadata. In one embodiment, transcript related data is primarily sequentially stored or indexed data including data related to the transcript including words, lines and dialog exchanges as well as scene related data. Metadata is primarily secondary or reference related data accessed upon user request such as dictionary data, pronunciation data and content related indices.

In one embodiment, transcript data is stored in a flat sequential binary format 600. Flat format 600 includes multiple sections related to the transcript grouped according to a defined hierarchy. The data in each section is organized in a sequential manner following the sequence of the transcript. In one embodiment the fields in the format have a fixed length. In one embodiment, the sections include a word section, line section, dialog exchange section, scene section and other similar sections. The word section includes a word instance index that identifies the position of the word in the word section sequence, the word text, a word definition identification or pointer to link the word to definition data, a pronunciation identification field or pointer to link the word to related pronunciation data and starting and end frame fields to identify the starting and ending frames from video content 127 that the word is associated with. In one embodiment, the line section includes a line index that identifies the position of each line in the line section sequence, a starting word index to indicate the first word in the word section that is associated with the line, an ending word index to indicate the last word associated with the line, a line explanation index to indicate or point to data related to the language explanation of the line of the transcript, a character identification field to point to or link the line with a character in video content 127, starting and ending frame indicators and similar information or pointers to information related to the line. In one embodiment, the dialog exchange section includes an exchange index to identify the position in the index of the dialogue exchange section a starting frame and an ending frame associated with the dialogue exchange and similar pointers and information. In one embodiment, the scene section includes an index to identify the position of a scene in the scene section, a preamble identification field or pointer, a postamble identification field or pointer, starting and end frames and similar indicators and information related to a scene.

In one embodiment, the metadata sections include a line explanation section, a word dictionary section, a word pronunciation section and similar sections related to secondary and reference type information related to video content 127 and language therein. In one embodiment, an explanation section would include an index to indicate the position of the line explanation in the line explanation section, a line index to indicate the corresponding line, a set of explanation data fields related to the various types of grammatical and semantic explanation data provided for a given line and similar fields related to data corresponding to a line explanation. In one embodiment, the word pronunciation section includes an index to indicate the position of an instance in the word pronunciation section, a pointer to audio data, a length of audio data field, an audio data type field and similar pronunciation related data and pointers.

In one embodiment, pointers are used in fields to indicate data that is larger than the field size in the binary file. This allows flexibility in the size of data used while maintaining a standard format and length for the fields in the binary file. In one embodiment, companion source files 115 have alternate formats for editing and file creation such as XML and other markup languages, databases (e.g., relational databases) or objected oriented formats. In one embodiment, companion source files 115 are stored in a different format on server 119. In one embodiment, companion source files 115 are stored as relational database files to facilitate the dynamic modification of the files when being created or edited. The databases are flattened into a flat file format to facilitate access by player software 105 during playback.

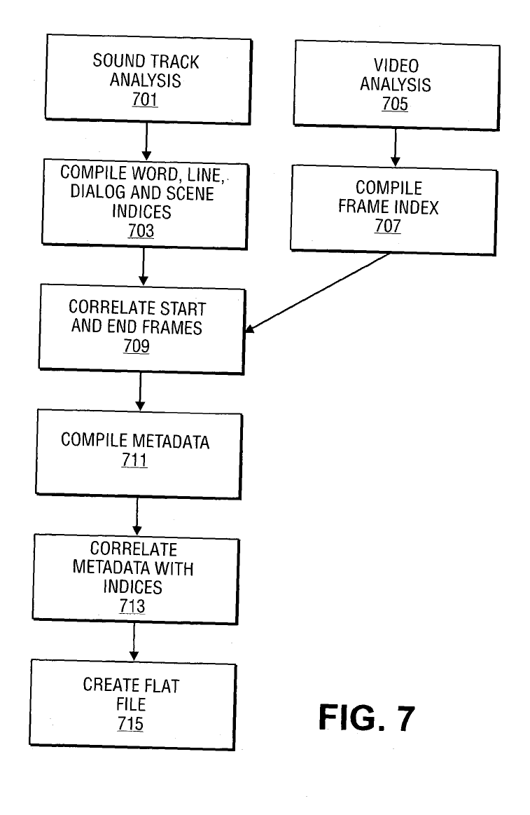

FIG. 7 is a flow chart for creating of a companion source file 115 providing additional content. In one embodiment, a soundtrack of video content 127 is analyzed, for example, to identify all words, sentences, dialogues, and similar constructs used therein (block 701). The analysis may be done entirely by an editor or may be partially computer generated and reviewed by an editor. A set of indices is created based upon the analysis including a word index of all the words spoken in video content 127 (block 703). Other indices generated include line, dialog exchange and scene indices that provide a hierarchical organization of the words in video content 127. In one embodiment, video content 127 is analyzed to identify frames, scenes, chapters and similar constructs (block 705). A frame index is compiled including scene, chapter and similar information (block 707). In one embodiment, the indexed words, lines, dialogs and scenes are associated with the start frame and end frame of the sequence of frames related to each instance in the indices (block 709). Such links may provide direct access to the associated video frame in which the word is spoken.

In one embodiment, additional material (i.e., metadata) related to the indexed words, lines, dialogs and scenes including dictionary references, pronunciation information, line explanations grammatical information and similar data is compiled into indexes and a variable length data section (block 711). The compiled metadata is then correlated with the indices to create a set of pointers from the indexed entries to the indexed metadata and from the indexed metadata to the variable length data section (block 713). In one embodiment, this information and related set of dependencies is stored in a database on server 119. In one embodiment, flat files for use with player software 105 can be created by formatting the data in the database files according to a pre-defined flat file format 600 readable by player software 105 (block 715). In one embodiment, the flat files are generated by an exporting or publishing application. Flat files organized with data in a sequential manner offer fast access and easy correlation with video content 127 to player software 105.

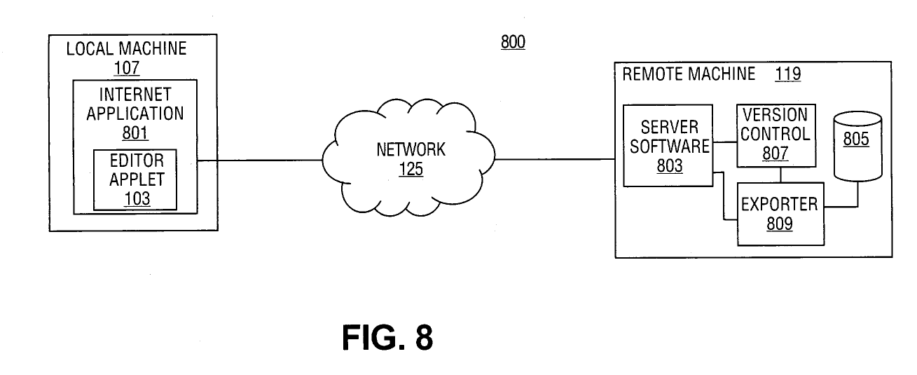

FIG. 8 illustrates an exemplary editing system 800 for generating and editing companion source files 115. In one embodiment, editing system 800 includes a local machine 107 for running an editing application 103. In one embodiment, editing application 103 is an applet that is associated with an Internet browser 801 or similar application also running on local machine 107. In one embodiment, editing application 103 accesses a remote machine 119 over a network 125. In one embodiment, remote machine 119 runs a server application 803 and includes a storage unit 805. In one embodiment, server 803 provides access to databases, companion source files 115 and similar resources stored on storage unit 805.

In one embodiment, server software 803 works with version control software 807 to allow access to companion source file modules by an editing application 103 while maintaining the coherency of companion source files 115. In one embodiment, server application 803 and version control software 807 work with an exporting application 809 that formats companion file source data stored on storage unit 805. In one embodiment, exporting application 809 takes companion source file data stored in a database on storage unit 805 and creates a flat file using format 600 to be sent to editing application 103. Exporting application 809 can also generate flat companion source files 115 for storage on media such as a CD, DVD, magnetic disk, hard disk, peripheral device, solid state memory medium, network connected storage medium or Internet connected device to be used with player software 105.

In one embodiment, editing application 103 enables a user to create a catalog of scenes related to video content 127. This catalog of scenes can be accessed as a menu by a user of player software 105 to facilitate the navigation of video content 127. This allows a user of player software 105 to more easily review segments of video content 127. In one embodiment, a user of editing application 103 can compile a list of frames from video content 127 to include in a catalog, guide, menu or similar interface tool. Editing application 103 creates a catalog using the selected frames. In one embodiment, editing application 103 automatically generates a menu display based on the selected frames and includes phrases associated with each frame and index point of the frame so that the user of player software 105 can see a frame and phrase of dialogue in a menu and choose a frame to start playback at that frame. In one embodiment, editing application 103 generates a catalog of video frames or graphical representation of video frames associated with a video content 127 to allow easy access to the frames during editing especially in correlating the audio, transcript and video frames. Catalogs can be compiled based on sentence content, dialog exchange character, topics, scenes and similar criteria.

In one embodiment, editing application 103 allows the creation of drills, trivia questions, pop-up definition and pronunciation content, and similar content to be associated with a video content 127 section. In one embodiment, a user constructs preamble and postamble screens associated with video content 127 or scenes within a video content 127. Some content may be automatically generated by editing application 103 based on editor selections for the preamble and post amble. The user can modify this automatically generated content.

In one embodiment, editing application 103 allows for the access and modification of other databases and files stored on server 119. In one embodiment, editing application 103 allows for the modification of a dictionary file stored on server 119 or on local machine 107. The dictionary file may be incorporated into a companion module or into player software 105.

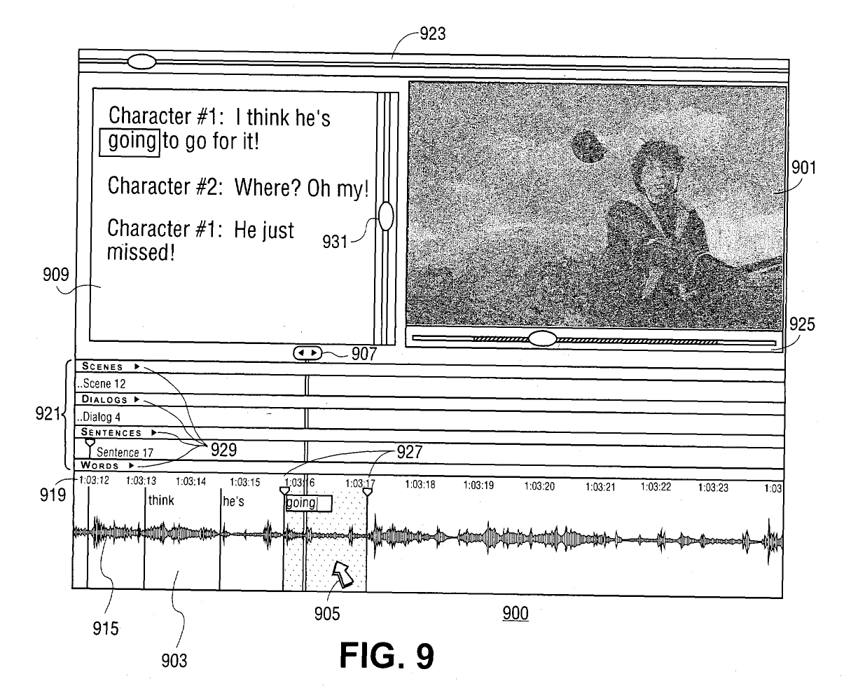

FIG. 9 is an illustration of an editor interface 900. In one embodiment, editor interface 900 is in the form of a window such as a window supported by Microsoft Windows® published by Microsoft® Corporation. In one embodiment, editor interface 900 is a full screen application. In one embodiment, editor interface 900 includes a video content 127 view screen 901. Video view screen 901 displays a video frame from video content 127 that is related to companion source module 115, which the user is editing. In one embodiment, video content 127 must be available to the local machine on a fixed storage drive 207 or similar device or through a removable media drive 205 or similar device. In one embodiment, editor interface 900 supports video content 127 playback. This playback can be in video content 127 view screen 901 or in a full screen mode. The playback function allows the user of editing application 103 to verify the accuracy of the edits to companion source file 115. In one embodiment, video view screen 901 is associated with a scroll bar 923 that allows a user to scan forward and back in a particular scene, segment or the whole of a video content.

In one embodiment, editor interface 900 also includes a transcription view screen 909. Transcription view screen 909 allows a user to modify a transcript associated with video content 127. In one embodiment, the user can also use the transcription view screen 909 to associate a word or group of words with a segment of an audio track. In one embodiment, transcription view screen 909 displays other text information related to video content 127 that may be edited such as dictionary information, pronunciation information and similar companion source data.

In one embodiment, the audio track associated with video content 127 is displayed in audio track display 903. Display 903 shows waveform 915 of the audio track. In one embodiment, a reference position 907 for waveform 915 can be dragged or scrolled to the left or right to chronologically advance or regress the audio track reference point using a tab 907. In one embodiment, audio track display 903 can be used to identify words in the waveform and associate the words or segments of the waveform with the transcription. In one embodiment, conventional techniques such as drag and drop and cursor highlighting are used to mark the waveform and match a marked region with a word or set of words in the transcript. In one embodiment, text entries to the transcript can be directly entered into the audio track display 903. Editor interface 900 can be used with a cursor 905 to access each of the content areas of the interface. Cursor 905 can be controlled by a peripheral device (e.g., a mouse, control pad or similar device). In one embodiment, editor interface 900 includes a time code bar 919 for referencing the video, audio and transcript information to a specific time sequence, frame count or similar structure. Editor interface 900 includes a position display 921 that indicates the scene, dialog, sentence and word that reference marker 907 is currently positioned through. Drop down menus or similar access devices can be activated through display 921 to alter the position of reference marker 907 in relation to a scene, dialog, sentence or word.

In one embodiment, sliders and scan bars used in interface 900 allow the user to job and shuttle over video, waveform and time codes. In one embodiment, scroll bar 923 allows user to advance or regress the sequence to be displayed in transcript screen 909, video display screen 901, audio display screen 919, and reference position display 921. Scroll bar 923 allows access to an entire video content 127, companion source file or module. Scroll bar 925 allows access to a scene, dialog, sentence or word. Multiple scroll bars give different ranges of access to provide ease of use to a user in obtaining the appropriate level of granularity in accessing material to facilitate the editing process. In one embodiment, editing application 103 includes sticky points for areas around syllables and similar division points in audio display 903 to facilitate labeling waveform 915. A sticky point is a reference point that a cursor can easily indicate or gravitate towards. In one embodiment, sliders, scroll bars or the like are color coded to indicate a section of the associated content that has been viewed, worked on or completed. In one embodiment, an editor using editing interface 900 can mark a section of waveform 915 by clicking on the waveform to set a start point or end point of a word causing adjustable delimiting markers 927 to appear. These delimiting markers 927 gravitate toward sticky points defined by probable gaps between words in waveform 915. Once highlighted a word can be associated with the transcript using window 909, which is manipulate by scroll bar 931. In addition the editor can click in the highlighted portion between delimiting markers 927 to input the text of the highlighted word. Playback buttons 929 can be used to play a video content starting at a displayed word, sentence, dialog or scene as indicated in display 921. These playback buttons facilitate the quick verification of the editing process.

In one embodiment, editing application 103 includes a set of additional interfaces that are specialized to the production of additional material such as dictionary definitions, explanation materials or similar materials. These specialized interfaces facilitate the quick and efficient production of additional materials to be included in a companion source file 115. For example, an editing application 103 may include a specialized interface for the recording of audio tracks for use in the pronunciation materials. In another embodiment, a specialized application is used instead of specialized interfaces.

In one embodiment, an editor creating a companion source module first obtains a template from version control program 807 and exporting application 809. The user types a transcript in the transcript view screen while viewing and listening to video content 127 associated with the companion source module. In one embodiment, after the transcription is complete, the editor correlates the transcript to the audio waveform and to the frames of video content 127. In one embodiment, editing application 103 automatically correlates the transcript to the waveform and frames of video content 127. In this embodiment, the editor can adjust the linking of the transcript with the waveform and video content 127 and verify the accuracy of the module.

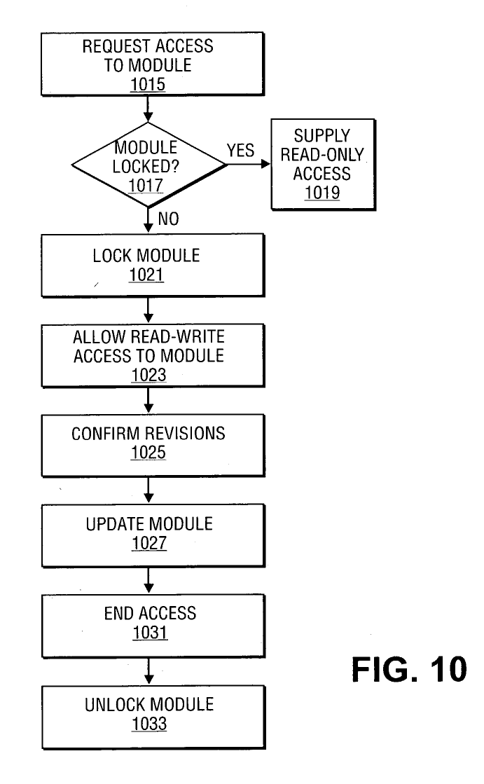

FIG. 10 is a flow-chart depicting the process version control software 807 follows to maintain companion source module coherency. In one embodiment, companion source files 115 are files that contain information and language materials related to a specific video content 127 such as a feature film or television program that is stored on media such as a DVD. In one embodiment, language materials are intended to teach a language of video content 127 to a language student. In one embodiment, companion source files 115 may be subdivided into modules to facilitate sending them over the internet to machines with slow connections and to allow multiple users to access, edit or manage different segments of a companion source file 115. In one embodiment, the companion source file data is stored in a database such as a relational database on server 119. Storing the companion source file data in a database allows for a higher level of efficiency in dynamically editing the data therein. In one embodiment, companion source files 115 on server 119 are a set of data values (e.g., words, audio files and similar data) associated with sets of dependencies. Version control software 807 controls access to the modules stored on server 119 to ensure that if a user modifies a module the most recent module is stored on server 119. In one embodiment, local copies of modules are made on local machine 107. In another embodiment, a complete local copy of the modules is not made, rather the data is primarily maintained on server 119 during the editing process. In one embodiment, portions of the modules are copied to local machine 107 to improve the responsiveness and speed of the editing process dependent on the quality of the network connection between local machine 107 and server 119.

In one embodiment, version control program 807 tracks which modules have been locked (e.g., an editor has requested and received access to the module). In one embodiment, version control program receives requests via network 125 from editing application 103 (block 1015). Program 807 then checks to see if the requested module is locked (block 1017). If the module is locked then version control program 807 offers editing application 103 read only access to the module (block 1019). In one embodiment, the user will be able to view the content of the module and make alterations to the module on a local machine but will not be able to upload the module to the server. If the module is not locked, then version control program 807 locks the requested module (block 1021). The module is then sent to editing application 103 with read and write privileges (block 1023). Editing application 103 may then alter the module and confirm the revisions to the module with version control program 807 (block 1025). Editing application 103 then sends the alterations of the module to version control program 807 over network 125. Version control program 807 then updates the database copy of the module with the revisions made by the user (block 1027). Once the updates are complete and the user quits the editing of the module version control program 807 ends the access to the module by editing application 103 (block 1031). The version control program then unlocks the module so that other users may access the module to modify it (block 1033). In one embodiment, the access to the modules is further restricted based on the identity requesting user or similar parameters. In this manner the users modifying a module or set of modules can be restricted to a designated group.

In one embodiment, metadata stored in a companion source file 115 is stored in a separate set of modules from transcript data. In this embodiment, an editor checks out a transcript module to work on and checks the transcript module back in to version control program 807 when finished. While working on the transcript module the editor checks out related metadata modules to make changes and checks them back in separately from the transcript module. In one embodiment, metadata modules have a high level of granularity in access (e.g., each dictionary entry is available as a separate module). This facilitates the ease of access to the metadata modules because metadata is often linked across multiple transcript modules and is needed by multiple editors. Minimizing the size of the metadata modules keeps a higher percentage of the metadata available to be edited.

In one embodiment, version control software 807 works in conjunction with exporting application 809 to provide companion source files 115 and modules to requesting editing applications 103. Exporting application 809 formats companion source data into a flat format 600 or similar format suitable for transmission over a network 125 and for use in the editing process. In one embodiment, exporting application 809 also unflattens the companion source data that is returned from the editing application 103 by formatting the companion source data for storage on server 119, interacting with a database management system to create appropriate entries to a database on server 119 based on the data in the flat files or through a similar process.

In one embodiment, version control software 807 controls access by editing applications 103 over network 125 to other libraries and databases stored on server 119. This allows for the modification of the databases by select users to add, delete or correct content of the libraries and files stored on server 119 from machines that are remote from server 119. In one embodiment, editing application 103 or a similar application includes an interface for a head editor to review the changes to files before confirming their entry through version control program 807.

In one embodiment, server 119 hosts a website containing information and resources related to languages and video content 127. The website includes a chat room for individuals interested in discussing video content 127 or a language. The website also provides a forum where users can provide feedback regarding video content 127 and rate the content. In one embodiment, the website catalogs video content 127 available, lessons or drills associated with a video content 127, approved editors, upcoming video content 127 and project status, purchase or rental options for video content 127, sample video content 127 and similar information. In one embodiment, the catalogs have restricted access based upon user status (e.g., registered user, editor or similar designation).

In one embodiment, language learning system 100 includes an online community and incentives system to encourage the creation of companion source files 115 and related databases and resources. This system provides low cost translation of video content 127 into transcripts and companion source files 115. In one embodiment, linguists are encouraged to contribute to the generation of transcriptions, translations, and companion source files by rewarding them with prizes and through a ratings system.

In one embodiment, the system includes a hierarchy of editors including at least a head editor associated with each companion source file 115. A head editor is responsible for the management of a companion source file 115. In one embodiment, the head editor does not produce any content for the companion source file, but mediates differences of opinion between editors and reviews their work product. The head editor assigns modules to other editors and is responsible for dividing companion source file 115 into modules. In one embodiment, editor ratings are based on the amount of involvement in the process and peer reviews.

In one embodiment, editors who are qualified linguists create additional content for use in companion source file 115 and online resources. Linguist editors will identify and explain idioms and dialog sequences and assist in creating drills, preamble sequences and postamble sequences. Linguists may identify incorrect grammar, indicate correct grammar and provide other corrective information regarding the transcripts of video content 127. In one embodiment, linguist editors create content pages including video frames, word definitions in multiple languages, idiom explanations in multiple languages, identification of slang and incorrect grammar with explanation and corrected grammar, dialect information, pronunciation information, explanations of abbreviations and similar information.

In one embodiment, each editor has an account including private and public portions. Editors involved in the work on a given module or companion source file 115 have private chat rooms to discuss and plan work related to the module or file through a website on server 119. Editors have access to server resources including modules, libraries, dictionaries, and databases. In another embodiment, an editor's access level is dependent on the editor's rating.

In one embodiment, editing application 103, player software 105, server software and other elements of language learning system 100 are implemented in software (e.g., microcode, assembly language or higher level languages). These software implementations may be stored on a machine-readable medium. A “machine readable” medium may include any medium that can store or transfer information. Examples of a machine readable medium include a ROM, a floppy diskette, a CD-ROM, a DVD, an optical disk or similar medium.

In the foregoing specification, the invention has been described with reference to specific embodiments thereof. It will, however, be evident that various modifications and changes can be made thereto without departing from the broader spirit and scope of the invention as set forth in the appended claims. The specification and drawings are, accordingly, to be regarded in an illustrative rather than a restrictive sense.

What is claimed is:

1. A method comprising:
accepting video content from a random access medium;
accepting additional content from a separate storage medium;
associating the additional content with the video content within a playback system; and
augmenting playback of the video content with the associated additional content to facilitate learning of a language.

2. The method of claim 1 wherein:
the additional content comprises other data of interest retained in a database; and
at least a subset of the database data is associated with at least one specific video frame.

3. The method of claim 2 further comprising:
navigating through a navigation system which allows a specific video frame to be accessed by selecting data within the database.

4. The method of claim 1 further comprising:
playing the video content associated with a plurality of sequentially adjacent words wherein the length and starting point of the sequence of words is responsive to a user input.

5. The method of claim 1 further comprising:
playing a plurality of sequentially adjacent words wherein the speed of playback is adjusted responsive to a user input.

6. The method of claim 5 further comprising:
adjusting the pitch of audible playback in relation to the speed of playback to improve intelligibility of the spoken words.

7. The method of claim 5 further comprising:
adjusting the time-spacing between spoken words in the playback in relation to the speed of playback to improve recognition of the spoken words.

8. The method of claim 7 wherein:
the individual spoken words between the time spaces have their original natural pitch and speech rate preserved.

9. The method of claim 3 further comprising:
playing the video content associated with a plurality of sequentially adjacent words wherein the length and starting point of the sequence of words is responsive to a user input is made through the navigation system.

10. The method of claim 1 wherein the random access video content medium is at least one of a CD, DVD, magnetic disks, optical storage media, local hard disk file, peripheral device, solid state memory medium, network-connected storage resource, or an Internet-connected storage resource.

11. The method of claim 1 wherein the separate storage medium is at least one of a CD, DVD, magnetic disks, optical storage media, local hard disk file, peripheral device, solid state memory medium, network-connected storage resource, or an Internet-connected storage resource.

12. The method of claim 1 further comprising:
presenting captions that are contained within the additional content, in an overlay on the video content; and
highlighting a word in the captions in synchronization with speaking of the word in a soundtrack of the video content.

13. The method of claim 1 further comprising:
creating a record of a plurality of inputs of a user;
inferring from the record a conclusion about needs or interests of a user; and
providing services responsive to the needs or interests of a user based on the conclusion.

14. The method of claim 1 further comprising:
reading information from the random access medium to determine if an authorized copy is present; and
providing access to the additional content only while the authorized copy is present.

15. The method of claim 1 further comprising:
creating a local copy of a portion of the video content;
reading information from the random access medium to determine if an authorized copy is present; and
maintaining the local copy only while the authorized copy is present.

16. The method of claim 1 further comprising:
creating a local copy of a portion of the video content;
reading information from the random access medium to determine if an authorized copy is present;
limiting access to the local copy when the authorized copy is not present.

17. The method of claim 1 further comprising:
presenting a preamble from the additional content before a defined sequence of frames of the video content is played.

18. The method of claim 17 wherein the preamble comprises:
content that provides advance information relating to words occurring in the defined sequence.

19. The method of claim 18 wherein the advance information comprises:
at least one of words occurring in the defined sequence, explanations of the words, pronunciations of the words, a question relating to the video content, information relating to a user's prior experience; and questions relating to a user's prior experience.

20. The method of claim 18 wherein the advance information comprises:
a link between a word occurring in the preamble and a portion of the video content.

21. The method of claim 17 further comprising:
indicating an availability of the preamble; and
presenting the preamble only upon receipt of an input from a user.

22. The method of claim 1 further comprising:
presenting a postamble from the additional content after a defined sequence of frames of the video content is played.

23. The method of claim 22 wherein the postamble comprises:
content that provides information relating to words occurring in the defined sequence.

24. The method of claim 23 wherein the related information comprises:
at least one of words occurring in the defined sequence, explanations of the words, a question about the video content, pronunciations of the words, information relating to a user's prior experience; and questions relating to a user's prior experience.

25. The method of claim 23 wherein the related information comprises:
a link between a word occurring in the postamble and a portion of the video content.

26. The method of claim 22 further comprising:
indicating an availability of the postamble; and
presenting the postamble only upon receipt of an input from a user.

27. The method of claim 24 further comprising:
presenting the question and providing a response period prior to automatically presenting an answer; and
presenting at least one of a portion of the video content and a portion of the additional content upon receipt of an input from a user prior to the automatic presentation of the answer.

28. The method of claim 22 wherein the additional content comprises:
at least one of advertising content, portions of video content from a separate random access medium; questions about the separate video content, information relating to a user's prior experience; and questions relating to a user's prior experience.

29. The method of claim 22 further comprising:
determining if the video content has ended; and
automatically presenting the postamble upon the end of the video content.

30. The method of claim 1 further comprising:
recording information including at least one of user inputs and a status of a process within the playback system; and
using the recorded information to resume the process at an appropriate point.

31. The method of claim 1 further comprising:
analyzing at least one of a user input, a context of the user input, a database of the video content, a database of the additional content, and a database of user information;
selecting at least one of a beginning and ending frame, a rate of playback, and a type of augmentation of the playback; and
replaying a sequence of frames from the video content defined by the beginning and ending frame, including the rate and augmented content.

32. The method of claim 1 further comprising:
providing a network-accessible communication environment to allow at least one of a user of the playback system and a creator of additional content, to interact with at least one other user or creator.

33. The method of claim 1, wherein the additional content includes an index of words spoken in a soundtrack of the video content, the method further comprising:
adjusting the speed of playback of the video content responsive to a user input;
adjusting at least one of pitch and time-spacing of the words to improve at least one of intelligibility and recognition; and
maintaining a correlation of words spoken to specific video frames by reference to the index.

34. The method of claim 1 wherein the additional content includes an index of words spoken in a soundtrack of the video content, the method further comprising:
providing a library of audible pronunciations for a plurality of the words in the index; and
playing the pronunciations in response to a user input.

35. The method of claim 34 further comprising:
playing the pronunciations in sequences defined by the soundtrack.

36. The method of claim 34 further comprising:
recording a pronunciation of a word by a user; and
presenting a comparison of the pronunciation of the word by the user with the pronunciation from the library.

37. The method of claim 36 wherein the comparison comprises:
presenting a graphical display of the pronunciations of the word by both the user and the library.

38. The method of claim 36 wherein presenting comprises:
analyzing the pronunciations into component elements; and
displaying the elements.

39. The method of claim 38 wherein presenting comprises:
correlating the component elements from the user's pronunciation with the library pronunciation; and
displaying a report.

40. A method comprising:
analyzing video content including a soundtrack;
creating a text index of words spoken within the video content; and
associating each word with at least one specific video frame during which the soundtrack contains the word spoken.

41. The method of claim 40 further comprising:
creating a dictionary of words spoken within the video content which associates each word with other data of interest.

42. The method of claim 40 further comprising:
creating a navigation system which allows a specific video frame to be accessed by selecting words within the index.

43. The method of claim 41 wherein the data of interest comprises at least one of:
a definition of the word, a translation of the word into another language, an example of usage of the word, an idiom associated with the word, a definition of the idiom, a translation of the idiom into another language, an example of usage of the idiom, a character in the video content who spoke the word, an identifier for a scene in which the word was spoken, and a topic which relates to the scene in which the word was spoken; and
wherein a database is created containing the data of interest.

44. The method of claim 43 further comprising:
creating a navigation system which allows a specific video frame to be accessed by selecting data within the database.

45. The method of claim 40 further comprising:
identifying additional content containing at least part of the index of words spoken and other data of interest;
instantiating the additional content on a storage medium separate from a medium containing the video content; and
associating the video content with the additional content to augment playback of the video content to facilitate learning of a language.

46. The method of 40 wherein analyzing comprises:
processing at least one of audio data representing the words spoken within the video content, a graphical representation relating to the sound of the words, and text data relating to the sound of the words; and
identifying at least one of the frame constituting the beginning and end of the sound corresponding to a discrete word.

47. The method of claim 46 further comprising:
presenting a video frame, the graphical representation relating to the sound of the words, and the text of the words concurrently within a display to facilitate identification of the frames corresponding to the discrete word.

48. The method of claim 47 further comprising:
providing a graphical user interface within the concurrent display including at least one of markers depicting the beginning and ending of a unit of sound corresponding to a word, a playback mechanism to view a plurality of frames with their associated word text and graphical representation responsive to a user input, a graphical indication of the video frames which have been indexed, and graphical controls which provide access to frames within the video content at varying levels of granularity.

49. The method of claim 40 further comprising:
including in the index the video frames corresponding to at least one of a spoken sentence, a dialog exchange, a character, a topic, and a scene.

50. The method of claim 40 further comprising:
connecting a local user of the index to a network; and
providing a user interface to permit the local user to modify information in the index; and
wherein the user interface permits at least one of access to dictionaries or libraries relating to the index, interaction with at least one other user, and operation via an Internet browser.

51. An apparatus comprising:
a subtitle translation module to translate subtitles existing in video content; and
a display module to display a translation of the subtitles in association with the subtitle translation.

52. A machine-readable medium that provides instructions, which when executed by a machine cause the machine to perform operations comprising:
accepting video content from a random access medium;
accepting additional content from a separate storage medium;
associating the additional content with the video content within a playback system; and
augmenting playback of the video content with the associated additional content to facilitate learning of a language.

53. A machine-readable medium that provides instructions, which when executed by a machine cause the machine to perform operations comprising:
analyzing video content including a soundtrack;
creating a text index of words spoken within the video content; and
associating each word with at least one specific video frame during which the soundtrack contains the words spoken.
